(19) United States
(12) Patent Application Publication
(10) Pub. No.: US 2024/0166233 A1
(43) Pub. Date: May 23, 2024

(54) INTERACTION-AWARE TRAJECTORY PLANNING

(71) Applicant: Honda Motor Co., Ltd., Tokyo (JP)

(72) Inventors: Piyush GUPTA, East Lansing, MI (US); David F. ISELE, Sunnyvale, CA (US); Sangjae BAE, San Jose, CA (US)

(21) Appl. No.: 18/188,323

(22) Filed: Mar. 22, 2023

Related U.S. Application Data
(60) Provisional application No. 63/422,193, filed on Nov. 3, 2022.

(51) Int. Cl. B60W 60/00; G06N 3/0464; G06N 3/0475

(52) U.S. Cl. CPC B60W 60/001; G06N 3/0464; G06N 3/0475

(57) ABSTRACT

According to one aspect, a system for interaction-aware trajectory planning may include a memory storing one or more instructions and a processor executing one or more of the instructions stored on the memory to perform one or more steps, one or more acts, or one or more actions. For example, the processor may perform determining an interaction-aware trajectory for an autonomous vehicle (AV) traveling in an operating environment including one or more other vehicles using model predictive control (MPC) optimization. The MPC optimization may integrate a neural network which receives one or more observations of the AV and one or more observations of one or more of the other vehicles and outputs predicted trajectories for the AV and one or more of the other vehicles a time step into the future. The processor may perform implementing the interaction-aware trajectory for the AV.

### CROSS-REFERENCE TO RELATED APPLICATIONS

This application claims the benefit of U.S. Provisional Patent Application, Ser. No. 63/422193 entitled “INTERACTION-AWARE TRAJECTORY PLANNING FOR AUTONOMOUS VEHICLES WITH ANALYTIC INTEGRATION OF NEURAL NETWORKS INTO MODEL PREDICTIVE CONTROL”, filed on Nov. 3, 2022; the entirety of the above-noted application(s) is incorporated by reference herein.

### BACKGROUND

Motion planning for autonomous vehicles (AVs) may be a daunting task, where AVs may share driving space with other drivers or vehicles. Driving in shared spaces may be an interactive task, and the AV's actions may affect other nearby vehicles and/or vice versa. This interaction may be evident in dense traffic scenarios where all goal-directed behavior relies on the cooperation of other drivers to achieve the desired goal. To predict the nearby vehicles' trajectories, AVs often rely on simple predictive models such as assuming constant velocity for other vehicles, treating them as bounded disturbances, or approximating their trajectories using a set of known trajectories. As a result, AVs equipped with such models struggle under challenging scenarios that require interaction with other vehicles.

### BRIEF DESCRIPTION

According to one aspect, a system for interaction-aware trajectory planning may include a processor and a memory. The memory may store one or more instructions. The processor may execute one or more of the instructions stored on the memory to perform one or more steps, one or more acts, or one or more actions. For example, the processor may perform determining an interaction-aware trajectory for an autonomous vehicle (AV) traveling in an operating environment including one or more other vehicles using model predictive control (MPC) optimization. The MPC optimization may integrate a neural network which receives one or more observations of the AV and one or more observations of one or more of the other vehicles and outputs predicted trajectories for the AV and one or more of the other vehicles a time step into the future. The processor may perform implementing the interaction-aware trajectory for the AV.

The neural network may be a social generative adversarial network (SGAN) or a graph-based spatial-temporal convolutional network (GSTCN). The MPC optimization may be solved using alternating direction method of multipliers (ADMM). The MPC optimization may be based on bicycle kinematics. The MPC optimization may be solved such that a non-convex optimization converges to a local optimum. The MPC optimization may be solved using canonical convex optimization. The MPC optimization may be solved using Broyden-Fletcher-Goldfarb-Shannos sequential quadratic programming (BFGS-SQP) by employing BFGS Hessian approximations within a sequential quadratic optimization. The MPC optimization may assume that outputs of the neural network are bounded. The MPC optimization may assume that gradients of the neural network with respect to an input trajectory of the neural network exist and are bounded. The MPC optimization may assume that the neural network outputs are Lipschitz differentiable.

According to one aspect, a computer-implemented method for interaction-aware trajectory planning may include determining an interaction-aware trajectory for an autonomous vehicle (AV) traveling in an operating environment including one or more other vehicles using model predictive control (MPC) optimization. The MPC optimization may integrate a neural network which receives one or more observations of the AV and one or more observations of one or more of the other vehicles and outputs predicted trajectories for the AV and one or more of the other vehicles a time step into the future. The computer-implemented method for interaction-aware trajectory planning may include implementing the interaction-aware trajectory for the AV.

The neural network may be a social generative adversarial network (SGAN) or a graph-based spatial-temporal convolutional network (GSTCN). The MPC optimization may be solved using alternating direction method of multipliers (ADMM). The MPC optimization may be based on bicycle kinematics. The MPC optimization may be solved such that a non-convex optimization converges to a local optimum. The MPC optimization may be solved using canonical convex optimization. The MPC optimization may be solved using Broyden-Fletcher-Goldfarb-Shannos sequential quadratic programming (BFGS-SQP) by employing BFGS Hessian approximations within a sequential quadratic optimization. The MPC optimization may assume that outputs of the neural network are bounded. The MPC optimization may assume that gradients of the neural network with respect to an input trajectory of the neural network exist and are bounded. The MPC optimization may assume that the neural network outputs are Lipschitz differentiable.

According to one aspect, a system for interaction-aware trajectory planning may include a processor and a memory. The memory may store one or more instructions. The processor may execute one or more of the instructions stored on the memory to perform one or more steps, one or more acts, or one or more actions. For example, the processor may perform determining an interaction-aware trajectory for an autonomous vehicle (AV) traveling in an operating environment including one or more other vehicles using model predictive control (MPC) optimization. The MPC optimization may integrate a neural network which receives one or more observations of the AV and one or more observations of one or more of the other vehicles and outputs predicted trajectories for the AV and one or more of the other vehicles a time step into the future. The neural network may be a social generative adversarial network (SGAN) or a graph-based spatial-temporal convolutional network (GSTCN). The processor may perform implementing the interaction-aware trajectory for the AV.

### BRIEF DESCRIPTION OF THE DRAWINGS

FIG. 1 is an exemplary component diagram of a system for interaction-aware trajectory planning, according to one aspect.

FIG. 2 is an exemplary flow diagram of a computer-implemented method for interaction-aware trajectory planning, according to one aspect.

FIG. 3 is an illustration of an example computer-readable medium or computer-readable device including processor-executable instructions configured to embody one or more of the provisions set forth herein, according to one aspect.

FIG. 4 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multi-core processors and co-processors and other multiple single and multi-core processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle (AV) and/or self-driving vehicle powered by any form of energy. The AV may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, a motion planner, a trajectory predictor, among others.

An “agent”, as used herein, may be a machine that moves through or manipulates an environment. Exemplary agents may include robots, other vehicles, or other self-propelled machines. The agent may be autonomously, semi-autonomously, or manually operated.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

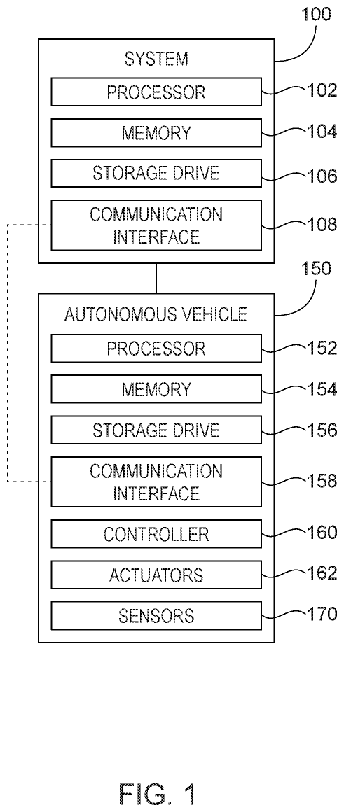

FIG. 1 is an exemplary component diagram of a system 100 for interaction-aware trajectory planning, according to one aspect. According to one aspect, the system 100 for interaction-aware trajectory planning may be implemented on a server remote from an autonomous vehicle (AV) 150, on a mobile device, or be passed through the mobile device and may include a processor 102, a memory 104, a storage drive 106, and a communication interface 108. According to another aspect, the system 100 for interaction-aware trajectory planning may be implemented on-board the AV 150. The AV 150 may include a processor 152, a memory 154, a storage drive 156, a communication interface 158, a controller 160, one or more actuators 162, and one or more sensors 170. Respective components may be operably connected and in computer communication with one another. Additionally, as seen in FIG. 1, the communication interface 108 of the system 100 for interaction-aware trajectory planning may be in computer communication with the communication interface 158 of the AV 150 (e.g., via a wireless connection, a telematics connection, etc.).

According to one aspect, sensors 170 may detect one or more observations of one or more other vehicles. According to another aspect, one or more observations of one or more other vehicles may be received by the communication interface 158 of the autonomous vehicle.

According to the aspect described herein, the system 100 for interaction-aware trajectory planning may be implemented on the server remote from the AV 150, and the storage drive 106 of the system 100 for interaction-aware trajectory planning may store a model predictive control (MPC) optimization. Again, it will be appreciated that the system 100 for interaction-aware trajectory planning may be implemented on a mobile device or on-board the AV 150, and the storage device may still store the MPC optimization according to those aspects. In any event, a motion planner and/or trajectory predictor may be implemented via the processor 102, 152, memory 104, 154, storage drive 106, 156, controller 160, etc. The processor 102 may perform determining an interaction-aware trajectory for the AV 150, which may be traveling in an operating environment including one or more other vehicles using the MPC optimization.

The MPC optimization may be solved according to the following description by the processor 102 and the memory 104 of the system 100 for interaction-aware trajectory planning. The MPC optimization may receive one or more observations of the AV 150 and one or more observations of one or more other vehicles and determine an interaction-aware trajectory for the AV 150 based on the received observations. The observations may include a past trajectory of the AV 150 as well as the past trajectory of one or more of the other neighboring vehicles. The MPC optimization may integrate a neural network which receives one or more observations of the AV 150 and one or more observations of one or more of the other vehicles and outputs predicted trajectories for the AV 150 and one or more of the other vehicles a time step into the future. In this way, the trajectories of the AV 150 and one or more of the other vehicles may be predicted and a neural network, such as a social generative adversarial network (SGAN) may be utilized to capture this. The processor 102 may predict one or more trajectories of one or more of the other vehicles based on one or more of the observations and integrate this neural network in itself into the optimization problem or optimization equation, as will be discussed in greater detail below. Stated another way, the neural network may be analytically blended into the optimization problem or optimization equation. Essentially, the output of the neural network becomes the part of the optimization and this means the whole neural network comes inside the optimization.

Thereafter, the interaction-aware trajectory may be transmitted to the AV 150 via the communication interface 108 and implemented for the AV 150. The processor 152, controller 160, and actuators 162 may perform implementing the interaction-aware trajectory for the AV 150. In this way, an interaction-aware motion planner, implemented via the processor 102, for the AV 150 that interacts with surrounding vehicles to perform complex maneuvers in a locally optimal manner may be provided. The interaction-aware motion planner may use a neural network-based interactive trajectory predictor and analytically integrate it with model predictive control (MPC). The MPC optimization may be solved using alternating direction method of multipliers (ADMM) and thus, prove the algorithm's convergence. Additionally, guarantees that the solution will be locally optimal and convergence guarantees may be provided as part of the optimization problem setup.

The interaction-aware motion planner may use one or more of the predicted trajectories of one or more of the other vehicles to determine a collision free trajectory for the AV 150. An interaction-aware AV, as described herein, may open up a gap for itself by negotiating with other vehicles, e.g., by nudging them to either switch lanes or change velocities.

One challenge in designing interaction-aware planners may include predicting the reactions of surrounding vehicles to the ego vehicle or the AV's actions or operational maneuvers. This may call for modeling the complex behavior of other vehicles considering inter-vehicle dependencies. Data-driven approaches may be useful in capturing complex interactive behaviors between vehicles. Additionally, recurrent neural network architectures may be effective at predicting human driver motion, both in terms of accuracy and computational efficiency. Therefore, it may be desirable to leverage these data-driven methods to predict the interactive behavior of other vehicles, while using rigorous control theory and established vehicle dynamics models to ensure efficiency.

According to one aspect, an MPC based motion planner that incorporates the AV's decisions and surrounding vehicles' interactive behaviors into constraints to perform complex maneuvers is provided herein. Mathematical formulations for integrating the neural network's predictions in the MPC controller and obtaining a locally optimal solution are discussed below. The neural network integration and non-linear system dynamics may make the optimization highly non-convex and thus, challenging to solve analytically. Other efforts that integrate neural network prediction into the MPC may be numerical in nature and include heuristic algorithms to generate a finite set of trajectory candidates. Others have generated these candidates by random sampling of control trajectories, by generating spiral curves from source to target lane, or by utilizing a predefined set of reference trajectory candidates. Instead of solving the optimization, other approaches evaluate the cost of each candidate and choose the minimum cost trajectory that satisfies an efficiency constraint. For prior works, optimality may have been restricted to trajectory candidates only, and the MPC based motion planner performance may depend on the design of the heuristic algorithm.

The system 100 for interaction-aware trajectory planning of FIG. 1, on the other hand, does not require the use of heuristics, and thus may solve the optimization with provable optimality. The optimal solution provided by the system 100 for interaction-aware trajectory planning of FIG. 1 provides insights for designing more efficient MPC based motion planners and may be leveraged to compare trajectories obtained by other heuristic methods.

Benefits of the system 100 for interaction-aware trajectory planning of FIG. 1 may include reformulation of a highly complex MPC problem with a non-convex neural network and non-linear system dynamics and systematically solve the MPC problem using the Alternating Direction Method of Multiplier (ADMM) and investigation of mathematical properties of the ADMM algorithm for solving the MPC with an integrated neural network rather than using heuristics. Additionally, sufficient conditions on the neural network may be provided such that the ADMM algorithm in the non-convex optimization converges to a local optimum. In this way, a provable mathematical guarantee for the neural network-integrated MPC may be provided.

### Optimization Formulation and Controller Design

The controller 160 may be an MPC controller that leverages interactive behaviors of surrounding N E [symbol] vehicles conditioned on the ego vehicle's or AV's future actions. To leverage interactions, the controller 160 may integrate a neural network and interactively update controls with step-size Δt E [symbol] _{>0} based on its inference (e.g., predicted positions during updates). Additional details regarding the mathematical formulation of the MPC with the neural network are provided herein.

The MPC optimization may be based on bicycle kinematics and thus, bicycle kinematics may be implemented for the controller 160. The corresponding states may be [x, y coordinates, heading angle, velocity] denoted by z(τ)=[x(τ), y(τ), ψ(τ), v(τ)]^{T} for all τ ∈ {0, . . . , Tₚ} and control inputs may be [acceleration, steering angle] denoted by [a(τ), δ(τ)] for all τ ∈ {0, . . . , Tₚ−1} with the planning horizon Tₚ ∈ [symbol] . For brevity, let g(τ) denote any general function g(·) at discrete time-step τ ∈ [symbol] _{≥0} with respect to time t, i.e., g(τ)≡g(t+τΔt). Thus, the input to the neural network may include the AV trajectory, which may be an optimization variable, want the control variables (e.g., steering, acceleration) and what will be the future state of the AV 150. Since these variables impact the future trajectories of the other vehicles, that becomes an important neural network. The system may optimize those inputs for what future inputs have a best possible output from the neural network, which is the desired output.

At any time t, the MPC may be solved to obtain the optimal control trajectories Δ*(t) ∈ [symbol] ⊂ [symbol] ^{T}^{ₚ} and α*(t) ∈ A ⊂ [symbol] ^{T}^{ₚ}, and corresponding optimal state trajectory Z*(t) ∈ [symbol] ⊂ [symbol] ^{4t}^{ₚ}, where:

Δ*(t)=[δ*(0), . . . , δ*(Tₚ−1)]^{T}, [symbol] =[δₘᵢₙ, δₘₐₓ],

α*(t)=[α*(0), . . . , α*(Tₚ−1)]^{T}, A=[αₘᵢₙ, αₘₐₓ],

Z*(t)=[z*(1), . . . , z*(Tₚ−1)]^{T}, [symbol] =[δₘᵢₙ, δₘₐₓ],

### Objective Function

An objective of the controller 160 may be to move from a current lane to a target lane or a desired lane as soon as possible, while minimizing control effort and ensuring efficiency and smoothness without collisions. Let x^{ref} denote the maximum longitude coordinate until when the ego vehicle or AV 150 should transition to the target lane or the desired lane. Let ∥·∥ denote the Euclidean norm. For x<x^{ref}, the following objective or cost function J(Δ(t), α(t), Z(t)) may be utilized:

J=Σ_{τ=1}^{T}^{ₚ}λ_{div}∥y(τ)−y^{ref}∥²+Σ_{τ=1}^{T}^{ₚ}λᵥ∥v(τ)−v^{ref}∥^{2 (error)}

+Σ_{τ=0}^{T}^{ₚ}⁻¹λ_{δ}∥δ(τ)∥²+Σ_{τ=0}^{T}^{ₚ}⁻¹λₐ∥a(τ)∥² (control effort)

+Σ_{τ=0}^{T}^{ₚ}⁻¹λ_{Δδ}∥δ(τ)−δ(τ−1∥² (steering rate)

+Σ_{τ=0}^{T}^{ₚ}⁻¹λ_{Δa}∥a(τ)−a(τ−1∥² (jerk)

where Δ(t) ∈ [symbol] , 60 (t) ∈ A, and Z(t) ∈ [symbol] may be the planned steering, acceleration, and state trajectories, respectively. y^{ref} ∈ [symbol] and v^{ref} ∈ [symbol] _{>0} may be the reference latitude coordinate of the desired lane and desired velocity, respectively, provided by the MPC based motion planner.

### State Dynamics

Let \tilde{δ}, \tilde{α}, and \tilde{z} be the last or prior observed steering input, acceleration input and state of the AV 150, respectively. At any time t, the discrete-time kinematic bicycle model may be linearly approximated of the form z(τ+1)=f(δ(τ), a(τ), z(τ)) about (\tilde{δ}, \tilde{α}, \tilde{z}) to obtain the equality constraints for the optimization problem.

f(δ(τ),a(τ),z(τ))≈Ãδ(τ)+\tilde{B}a(τ)+\tilde{C}z(τ)+\tilde{D}, (1)

where Ã ∈ [symbol] ⁴, \tilde{B} ∈ [symbol] ⁴, \tilde{C} ∈ [symbol] ^{4×4}, and \tilde{D} ∈ [symbol] ⁴ may be constant matrices given by

$$\tilde{A} := \frac{\partial f}{\partial δ} {\vert}_{( \tilde{δ} , \tilde{α} , \tilde{z} )} , \tilde{B} := \frac{\partial f}{\partial a} {\vert}_{( \tilde{δ} , \tilde{α} , \tilde{z} )} , \tilde{C} := \frac{\partial f}{\partial z} {\vert}_{( \tilde{δ} , \tilde{α} , \tilde{z} )} ,$$

\tilde{D}:=f(\tilde{δ}, \tilde{α}, \tilde{z})−Ã\tilde{δ}−\tilde{B}ã−\tilde{C}\tilde{z}, respectively. Hence, the linearized system dynamics may be given by:

z(τ+1)=Ãδ(τ)+\tilde{B}a(τ)+\tilde{C}z(x)+\tilde{D}⇒Ãδ(τ)+\tilde{B}a(τ)+\tilde{C}z(τ)−z(τ+1)+\tilde{D}=0, (2)

The equality constraints based on the system dynamics over the Tₚ planning time-steps may be written as:

F(Δ, α, Z):=AΔ+Bα+CZ+D=0, (3)

Where A ∈ [symbol] ^{4T}^{ₚ}^{×T}^{ₚ}, B ∈ [symbol] ^{4T}^{ₚ}^{×T}^{ₚ}, C ∈ [symbol] ^{4T}^{ₚ}^{×T}^{ₚ}, and D ∈ [symbol] ^{4T}^{ₚ} may be constant matrices given by:

$$A = [ \begin{matrix}\tilde{A} & 0 & 0 & … \\ 0 & \tilde{A} & 0 & … \\ ⋮ & ⋮ & ⋮ & …\end{matrix} ] , B = [ \begin{matrix}\tilde{B} & 0 & 0 & … \\ 0 & \tilde{B} & 0 & … \\ ⋮ & ⋮ & ⋮ & …\end{matrix} ] , \\ C = [ \begin{matrix}- I & 0 & 0 & … \\ \tilde{C} & - I & 0 & … \\ 0 & \tilde{C} & - I & … \\ ⋮ & ⋮ & ⋮ & …\end{matrix} ] , D = [ \begin{matrix}\tilde{D} - \tilde{C} z ( 0 ) \\ \tilde{D} \\ \tilde{D} \\ ⋮\end{matrix} ] \qquad ( 4 )$$

where 0 and I denote the zero and identity matrix, respectively.

The system dynamics may be linearly approximated before solving the MPC to simplify the optimization. This may be possible because the control inputs obtained through the MPC may be only applied for one time-step (receding horizon control). Therefore, any linearization errors from previous time steps may be not introduced in the MPC optimization.

### Constraints

Constraints for collision avoidance depend on the trajectory prediction of the nearby other vehicles and the vehicle shape model. Let V denote the set of nearby vehicles surrounding the ego vehicle or the AV 150. Let ϕ(τ) be a trained neural network that jointly predicts the future trajectories of the ego vehicle and its surrounding vehicles for T_{pred} time-steps into the future based on their trajectories for T_{obs} time-steps in the past. ϕ(τ) may be given by:

$$ϕ ( τ ) : [ \begin{matrix}( x ( τ ) , y ( τ ) ) & … & ( {x}_{N} ( τ ) , {y}_{N} ( τ ) ) \\ ⋮ & ⋮ & ⋮ \\ ( x ( τ - {T}_{obs} + 1 ) , y ( τ - & … & ( {x}_{N} ( τ - {T}_{obs} + 1 ) , {y}_{N} ( τ - \\ {T}_{obs} + 1 ) ) & & {T}_{obs} + 1 ) )\end{matrix} ]$$

$$↓$$

$$[ \begin{matrix}( \hat{x} ( τ + 1 ) , \hat{y} ( τ + 1 ) ) & … & ( {\hat{x}}_{N} ( τ + 1 ) , {\hat{y}}_{N} ( τ + 1 ) ) ]\end{matrix}$$

with T_{pred}=1, where the first column represents the positions of the ego vehicle followed by the positions of N surrounding vehicles. Given the buffer of T_{obs} past observations until time-step τ, the coordinates of vehicle i ∈ V at time-step τ+1 may be represented as:

\hat{x}ᵢ(τ+1)=ϕ_{i,x}(τ), ŷᵢ(τ+1)=ϕ_{i,y}(τ), (5)

Examples of the neural network ϕ(τ) may include social generative adversarial networks (SGAN) and graph-based spatial-temporal convolutional networks (GSTCN). Thus, the neural network may be the SGAN or the GSTCN. SGAN may be a neural network which takes the past trajectories of vehicles in the environment and predict the future trajectories of one or more time steps into the future and using the output in the optimization. By doing this, the whole neural network becomes a part of the optimization.

Interactive predictions over the planning horizon Tₚ may be computed recursively using ϕ(t) with T_{pred}=1 based on the latest reactive predictions an AV positions from the MPC's candidate solution trajectory. The vehicle shape may be modeled using a single circle to obtain a smooth and continuously differentiable distance measure to enable gradient-based optimization methods. Let (x,y) and (\hat{x}ᵢ, ŷᵢ) be the position of the ego vehicle and the predicted positions of the surrounding vehicles i ∈ V (obtained using ϕ(τ)), respectively. Let r, rᵢ ∈ [symbol] _{>0} be the radius of circles modeling ego vehicle and vehicle i, respectively. The constraint for the ego vehicle with regard to the vehicle i may be:

dᵢ(x,y, \hat{x}ᵢ, ŷᵢ)=(x−\hat{x}ᵢ)²(y−ŷᵢ)²−(r+rᵢ+ε)²>0 (6)

where ε ∈ [symbol] _{>0} may be a boundary.

The vehicle shape may be modeled using the single circle model for its simplicity and to reduce the number of constraints. Other models for modeling the vehicle shape include the ellipsoid model and three circle model.

### Formulation of Optimization Problem

The optimization problem for the receding horizon control in a compact form may be represented as:

$$\begin{matrix}min \\ Δ a , Z\end{matrix} J = {Φ}_{1} ( Δ ) + {Φ}_{2} ( α ) + {Φ}_{3} ( Z ) , \qquad ( 7 )$$

$$subject to$$

$$F ( Δ , α , Z ) = 0 , {b}_{i} ( Z ) > 0 , i ∈ V \qquad ( 8 )$$

$$Δ ∈ D , α ∈ A , Z ∈ , \qquad ( 9 )$$

$$where$$

$${Φ}_{1} ( Δ ) = {\sum }_{τ = 0}^{{T}_{p} - 1} {λ}_{δ} {‖ δ ( τ ) ‖}^{2} + {\sum }_{τ = 0}^{{T}_{p} - 1} {λ}_{Δδ} {‖ δ ( τ ) - δ ( τ - 1 ) ‖}^{2} ,$$

$${Φ}_{2} ( α ) = {\sum }_{τ = 0}^{{T}_{p} - 1} {λ}_{a} {‖ a ( τ ) ‖}^{2} + {\sum }_{τ = 0}^{{T}_{p} - 1} {λ}_{Δ a} {‖ a ( τ ) - a ( τ - 1 ) ‖}^{2} ,$$

$${Φ}_{3} ( Z ) = {\sum }_{τ = 1}^{{T}_{p}} {λ}_{div} {‖ y ( τ ) - {y}^{ref} ‖}^{2} + {\sum }_{τ = 1}^{{T}_{p}} {λ}_{v} {‖ v ( τ ) - {v}^{ref} ‖}^{2} ,$$

$${b}_{i} ( Z ) = [ \begin{matrix}{d}_{i} ( x ( 1 ) , y ( 1 ) , {ϕ}_{i , x} ( 0 ) , {ϕ}_{i , y} ( 0 ) ) \\ ⋮ \\ {d}_{i} ( x ( {T}_{p} ) , y ( {T}_{p} ) , {ϕ}_{i , x} ( {T}_{p} - 1 ) , {ϕ}_{i , y} ( {T}_{p} - 1 ) )\end{matrix} ] .$$

### Alternating Direction Method of Multiplier (ADMM) Convergence

The optimization problem may be solved using ADMM to determine the ego vehicle's or the AV's trajectory. The MPC optimization may be solved using ADMM.

There may be many mathematical challenges associated with the MPC optimization problem. For example, the MPC optimization problem may have non-linear system dynamics, non-convex constraints, and dependence of the neural network predictions on its predictions in previous time steps (T_{obs}≠1). Systematic steps for solving the complex problem using ADMM, addressing the aforementioned mathematical challenges are described in greater detail below.

First, a Lagrangian may be constructed by moving the constraints, bᵢ(Z)>0, i ∈ V, in the optimization objective:

$$\begin{matrix}min \\ Δ a , Z\end{matrix} J = {Φ}_{1} ( Δ ) + {Φ}_{2} ( α ) + {Φ}_{3} ( Z ) - {\sum }_{i = 1}^{N} {λ}_{s}^{T} {b}_{i} ( Z ) , \qquad ( 10 )$$

$$subject to$$

$$F ( Δ , α , Z ) = 0 , \qquad ( 11 )$$

$$Δ ∈ D , α ∈ A , Z ∈ , \qquad ( 12 )$$

where λₛ ∈ [symbol] _{>0}^{T}^{ₚ} may be the vector of Lagrange multipliers. The optimization problem from equations (11-13) may be separable and the optimization variables Δ, α, Z may be decoupled in the objective function. The augmented Lagrangian may be given by:

$${ℒ}_{ρ} ( Δ , α , Z ) = {Φ}_{1} ( Δ ) + {Φ}_{2} ( α ) + {Φ}_{3} ( Z ) - {\sum }_{i = 1}^{N} {λ}_{s}^{T} {b}_{i} ( Z ) + {μ}^{⊤} F ( Δ , α , Z ) + ( \frac{ρ}{2} ) {‖ F ( Δ , α , Z ) ‖}^{2} \qquad ( 13 )$$

where ρ>0 may be the ADMM Lagrangian parameter and pt may be the dual variable associated with the constraint equation (12). The algorithm for solving the MPC optimization with ADMM may be seen at the Alternating Direction Method of Multiplier (ADMM) Algorithm section described in greater detail below. Details for solving each of the local optimization problems at iteration k, for solving the MPC are also described below. The MPC optimization may be solved such that a non-convex optimization converges to a local optimum. The MPC optimization may be solved using canonical convex optimization.

A. Update Δ^{(k+1)}=argmin_{Δ∈D} [symbol] _{ρ}(Δ, α^{(k)}, Z^{(k)})

The sub-optimization problem for Δ^{(k+1)} is given by:

$$arg {min}_{Δ} {\sum }_{τ = 0}^{{T}_{p} - 1} {λ}_{δ} {‖ δ ( τ ) ‖}^{2} + {\sum }_{τ = 0}^{{T}_{p} - 1} {λ}_{Δδ} {‖ δ ( τ ) - δ ( τ - 1 ) ‖}^{2} + {μ}^{k ⊤} A Δ + ( \frac{ρ}{2} ) {‖ A Δ - {c}_{Δ}^{( k )} ‖}^{2} \qquad ( 14 )$$

subject to δ(τ) ∈ [δₘᵢₙ, δₘₐₓ], where c_{Δ}^{(k)}=AΔ^{(k)}−F(Δ^{(k)}, α^{(k)}, Z^{(k)}) . It may be a convex problem; hence may use a canonical convex optimization algorithm to find the optimal solution.

B. Update α^{(k+1)}=argmin_{a∈A} [symbol] _{ρ}(Δ^{(k+1)}, α, Z^{(k)})

The sub-optimization problem for α^{(k+1)} may be given by:

$$arg {min}_{α} {\sum }_{τ = 0}^{{T}_{p} - 1} {λ}_{a} {‖ a ( τ ) ‖}^{2} + {\sum }_{τ = 0}^{{T}_{p} - 1} {λ}_{Δ a} {‖ a ( τ ) - a ( τ - 1 ) ‖}^{2} + {μ}^{k ⊤} B α + ( \frac{ρ}{2} ) {‖ B α - {c}_{α}^{( k )} ‖}^{2} \qquad ( 15 )$$

subject to a(τ) ∈ [aₘᵢₙ, aₘₐₓ], where c_{α}^{(k)}=Bα^{(k)}−F(Δ^{(k+1)}, α^{(k)}, Z^{(k)}). It may be a convex problem; hence may use a canonical convex optimization algorithm to find the optimal solution.

C. Update Z^{(k+1)}= [symbol] [symbol] _{ρ}*(Δ^{(k+1)}, α^{(k+1)}, S)

The sub-optimization problem for Z^{(k+1)} may be given by:

$$arg {min}_{Z} {\sum }_{τ = 1}^{{T}_{p}} {λ}_{div} {‖ y ( τ ) - {y}^{ref} ‖}^{2} + {\sum }_{τ = 1}^{{T}_{p}} {λ}_{v} {‖ v ( τ ) - {v}^{ref} ‖}^{2} - {\sum }_{i = 1}^{N} {λ}_{s}^{T} {b}_{i} ( Z ) + {μ}^{k ⊤} CZ + ( \frac{ρ}{2} ) {‖ CZ - {c}_{Z}^{( k )} ‖}^{2} \qquad ( 16 )$$

subject to

z(τ) ∈ [zₘᵢₙ, zₘₐₓ] (17)

where c_{Z}^{(k)}=CZ^{(k)}−F(Δ^{(k+1)}, α^{(k+1)}, Z^{(k)}). Due to the nonconvexity of the neural network incorporated in bᵢ(Z), for i ∈ V, the objective function from equation (17) may be non-convex. The Quasi-Newton method may be utilized to solve the optimization to avoid an expensive Hessian computation at each step. According to one aspect, the MPC optimization may be solved using Broyden-Fletcher-Goldfarb-Shannos sequential quadratic programming (BFGS-SQP) by employing BFGS Hessian approximations within a sequential quadratic optimization. In this way, the BFGS-SQP method may be utilized, to employ BFGS Hessian approximations within a sequential quadratic optimization algorithm, and does not assume any special structure in the objective or constraints. For a solver, PyGranso may be used, a

PyTorch-enabled port of GRANSO, that enables computation of gradients by back-propagating the neural network's gradients at each iteration.

The state trajectory Z update may have a larger complexity in the problem due to the presence of the non-convex neural network predictions. Z update may be made faster by pre-computing the gradients of the neural network offline and storing them in a lookup table. This may be done by discretizing the feasible space around the AV 150 or the ego-vehicle with the AV 150 or the ego-vehicle at the center of the coordinate frame.

Alternating Direction Method of Multiplier (ADMM) Algorithm
ADMM Algorithm: MPC with ADMM

| | Init | | : states z = z₀ |
|---|---|---|---|
| | | | controls δ = δ₀, a = a₀ |
| | | | Surrounding vehicles' position: |
| | | | (xᵢ, yᵢ) = (x_{i,0}, y_{i,0}) for all i ϵ V |
| 1 | while x < x^{ref} and y ≠ y^{ref} do | | |
| 2 | \| Find the optimal control that minimizes the cumulative cost over horizon Tₚ | | |
| | \| Init : \hat{Δ} = Δ₀, \hat{α} = α₀, \hat{Z} = Z₀, \hat{μ} = μ₀ | | |
| 3 | \| while convergence criterion may be not met do | | |
| 4 | \| | \| | \hat{Δ}← argmin_{Δ} [symbol] ₚ(Δ, \hat{α}, \hat{Z}) |
| 5 | \| | \| | \hat{α} ← argmin_{α} [symbol] ₚ(\hat{Δ}, α, \hat{Z}) |
| 6 | \| | \| | \hat{Z} ← argmin_{Z} [symbol] ₚ(\hat{Δ}, \hat{α}, Z) |
| 7 | \| | \| | \hat{μ} ← \hat{μ} + p (F(\hat{Δ}, \hat{α}, \hat{Z})) |

| 8 | \| | end |
|---|---|---|
| 9 | \| | Update the states through non-linear state dynamics with the first elements |
| | \| of controls | |
| 10 | \| | z ← ƒ ([\hat{Δ}]₀, [\hat{α}]₀, z) |
| 11 | \| | Observe positions of other vehicles at the current time t |
| 12 | \| | (xᵢ, yᵢ) ← (xᵢ(t), yᵢ(t))for all i |

| | |
|---|---|
| 13 | end |

### Convergence of MPC with ADMM

Due to the inherent non-convexity of the neural network, the rigorous convergence analysis of ADMM may be not readily applicable. Thus, we extend the convergence analysis of ADMM with an integrated neural network, e.g., the convergence of the inner while loop in Alternating Direction Method of Multiplier (ADMM) Algorithm. Assumptions regarding the neural network may be made:
(A1) At any time-step τ ∈[0, Tₚ], the neural network's outputs may be bounded, i.e., ∥ϕ_{i,x} (τ)∥≤sₓ and ∥ϕ_{i,y} (τ)∥≤s_{y}, i ∈ V, where sₓ, s_{y} ∈ [symbol] _{>0} may be constants. Thus, the MPC optimization may assume that outputs of the neural network are bounded.
(A2) At any time-step τ ∈[0, Tₚ], the gradients of the neural network's outputs with regard to the input ego trajectory exist and may be bounded i.e.,

$${‖ \frac{\partial {ϕ}_{i , x} ( t )}{\partial Z} ‖}_{∞} \leq {θ}_{x} and {‖ \frac{\partial {ϕ}_{i , y} ( t )}{\partial Z} ‖}_{∞} \leq {θ}_{y}$$

for all i ∈ V where θₓ, θ_{y} ∈ [symbol] _{>0} may be constants and ∥·∥_{∞} may be the max norm of a vector. Thus, the MPC optimization may assume that gradients of the neural network with respect to an input trajectory of the neural network exist and are bounded.
(A3) At any time-step τ ∈[0, Tₚ], the neural network's outputs may be Lipschitz differentiable, i.e. ∥∇ϕ_{i,x}(Z₁)−∇ϕ_{i,x}(Z₂)∥≤L_{∇}_{_{ϕ}}∥Z₁Z₂∥ and ∥∇ϕ_{i,y}(Z₁)−∇ϕ_{i,y}(Z₂)∥≤L_{∇}_{_{ϕ}}∥Z₁Z₂∥ for all i ∈ V, Z₁, Z₂ ∈ [symbol] , where L_{∇}_{_{ϕ}} ∈ [symbol] _{>0} may be the Lipschitz constant for the gradient of the neural network. Thus, the MPC optimization may assume that the neural network outputs are Lipschitz differentiable.

Assumptions (A1)-(A3) may be sufficient conditions under which the objective function (11) may be a Lipschitz differentiable function, e.g., it may be differentiable and its gradient may be Lipschitz continuous. This allows the convergence of the Alternating Direction Method of Multiplier (ADMM) Algorithm. Assumption (A1) may be satisfied for a trained neural network ϕ for a bounded input space. Furthermore, each output of the neural network may be clipped based on the vehicles feasible space. Lastly, neural networks with C² activation functions such as

Gaussian Error Linear Unit (GELU) and Smooth Maximum Unit (SMU) satisfy assumptions (A2) and (A3).

Assumptions (A1)-(A3) may be sufficient conditions and not necessary conditions. If the neural network architecture may be unknown or it doesn't satisfy the assumptions, knowledge distillation may be used to train a smaller (e.g., student) network that satisfies the assumptions from the large (e.g., teacher) pre-trained network.

Theorem 1: [Convergence of MPC with ADMM] Under the assumptions (A1)-(A3), the inner while loop in Alternating Direction Method of Multiplier (ADMM) Algorithm converges subsequently for any sufficiently large ρ>max{1, (1+2σₘᵢₙ(C))LⱼM}, where σₘᵢₙ(C) may be the Lipschitz constant for J in (11), and M may be the Lipschitz constant for sub-minimization paths as defined in Lemma 2. Therefore, starting from any Δ^{(O)}, α⁽⁰⁾, Z⁽⁰⁾, μ⁽⁰⁾, it generates a sequence that may be bounded, has at least one limit point, and that each limit point Δ*, α* , Z* , μ* may be a stationary point of [symbol] _{ρ} satisfying ∇ [symbol] _{ρ}(Δ*, α* , Z* , μ*)=0.

Lemma 1: [Feasibility] Let Q :=[A, B]. Im(Q) ⊆ Im(C), where Im(·) returns the image of a matrix, and A, B, and C may be defined in (4)

Lemma 2: [Lipschitz sub-minimization paths] The following statements hold for the optimization problem:
(i) for any fixed α, Z, H₁: Im(A)→ [symbol] ^{T}^{ₚ} defined by H₁(u) [symbol] argmin_{Δ}{J(Δ, α, Z): AΔ=u} may be unique and a Lipschitz continuous map,
(ii) for any fixed Δ, Z, H₂: Im(B)→ [symbol] ^{T}^{ₚ} defined by H₃(u) [symbol] argmin_{α}{J(Δ, α, Z): Bα=u} may be unique and a Lipschitz continuous map,
(iii) for any fixed Δ, α, H₃: Im(C)→ [symbol] ^{4T}^{ₚ} defined by H₄(u) [symbol] argmin_{Z}{J(Δ, α, Z): CZ=u} may be unique and a Lipschitz continuous map,

where A, B, and C may be defined in (4). Moreover, H₁, H₂, H₃ have a universal Lipschitz constant M>0.

Lemma 3: [Lipschitz Differentiability] Under the assumptions (A1)-(A3), the objective function J(Δ, α, Z) in (11) may be Lipschitz differentiable.

### Proof of Lemma 1

C in (4) may be a lower triangular matrix with diagonal entries as −1. Hence, C may be a full rank matrix of rank 4Tₚ, and Im(C)→ [symbol] ^{4T}^{ₚ}. Im(Q)={y ∈ [symbol] ^{4T}^{ₚ}∥y=Qₓ=[A, B]x such that x ∈ [symbol] ^{2T}^{ₚ}} ⊆ [symbol] ^{4T}^{ₚ}=Im(C).

### Proof of Lemma 2

A and B may be full rank matrix of rank 4Tₚ. Therefore, their null spaces may be trivial, and hence, H₁, H₂, H₃ reduces to linear operators and satisfies the Lemma 2.

### Proof of Lemma 3

Φ₁(Δ), Φ₂(α), and Φ₃(Z) may be C² functions, and hence, Lipschitz differentiable. Therefore, to show the Lipschitz differentiability of J, it may be sufficient to show that bᵢ(Z),i ∈ V, may be Lipschitz differentiable for any τ ∈ {1, . . . Tₚ}. For brevity of space, define notations in terms of w ∈ {x, y} where w may either be x or y. Let q_{w}(τ):=2(w(τ)−ϕ_{i,w}(τ−1)).

$$\frac{\partial {b}_{i} ( Z )}{\partial x ( k )} = \{ \begin{matrix}- {q}_{x} ( τ ) \frac{\partial {ϕ}_{i , x} ( τ - 1 )}{\partial x ( k )} - {q}_{y} ( τ ) \frac{\partial {ϕ}_{i , y} ( τ - 1 )}{\partial x ( k )} , & for k \leq τ - 1 \\ {q}_{x} ( τ ) , & for k = τ \\ 0 , & for k ∈ \{ τ + 1 , … , {T}_{p} \}\end{matrix}$$

Let

$${T}_{k}^{w} := \vert \frac{\partial {b}_{i} ( {Z}_{1} )}{\partial w ( k )} - \frac{\partial {b}_{i} ( {Z}_{2} )}{\partial w ( k )} \vert$$

for some Z₁, Z₂ ∈ [symbol] and let (x^{m}(τ), y^{m}(τ)) denote the ego vehicle positions in Zₘ, where m ∈ {1,2}. Let ϕ_{i,w}^{Z}^{ₘ} denote ϕ_{i,w}, corresponding to Zₘ. Using assumption (A2) and mean-value theorem, the neural network's outputs may be Lipschitz continuous, e.g., ∥ϕ_{i,w}^{Z}^{₁}−ϕ_{i,w}^{Z}^{₂}∥≤θ_{w}∥Z₁−Z₂. Let Δw(τ)=|w¹(τ)−w²(τ)|, φ_{w}(τ−1)=|ϕ_{i,w}^{Z}^{₂}−(τ−1)|, and

$${v}_{x}^{w} ( τ - 1 ) = \vert \frac{\partial {ϕ}_{i , w}^{{Z}_{1}} ( τ - 1 )}{\partial x ( k )} - \frac{\partial {ϕ}_{i , w}^{{Z}_{2}} ( τ - 1 )}{\partial x ( k )} \vert .$$

### For any k ∈ {1, . . . , τ−1}:

$${T}_{k}^{x} \leq 2 Δ x ( τ ) \vert \frac{\partial {ϕ}_{i , x}^{{Z}_{1}} ( τ - 1 )}{\partial x ( k )} \vert + 2 Δ y ( τ ) \vert \frac{\partial {ϕ}_{i , y}^{{Z}_{1}} ( τ - 1 )}{\partial x ( k )} \vert + 2 \vert {x}^{2} ( τ ) \vert {v}_{x}^{x} ( τ - 1 ) + 2 {φ}_{x} ( τ - 1 ) \vert \frac{\partial {ϕ}_{i , x}^{{Z}_{2}} ( τ - 1 )}{\partial x ( k )} \vert + 2 \vert {y}^{2} ( τ ) \vert {v}_{x}^{y} ( τ - 1 ) + 2 {φ}_{y} ( τ - 1 ) \vert \frac{\partial {ϕ}_{i , y}^{{Z}_{2}} ( τ - 1 )}{\partial x ( k )} \vert + 2 \vert {ϕ}_{i , x}^{{Z}_{1}} ( τ - 1 ) \vert {v}_{x}^{x} ( τ - 1 ) + 2 \vert {ϕ}_{i , y}^{{Z}_{1}} ( τ - 1 ) \vert {v}_{x}^{y} ( τ - 1 ) \leq 2 {θ}_{x} Δ x ( τ ) + 2 {x}_{max} {v}_{x}^{x} ( τ - 1 ) + 2 {θ}_{x} φ x ( τ - 1 ) + 2 {s}_{x} {v}_{x}^{x} ( τ - 1 ) + 2 {θ}_{y} Δ y ( τ ) + 2 {y}_{max} {v}_{x}^{y} ( τ - 1 ) + 2 {θ}_{y} {φ}_{y} ( τ - 1 ) + 2 {s}_{y} {v}_{x}^{y} ( τ - 1 ) = {L}_{1} ‖ {Z}_{1} - {Z}_{2} ‖$$

where

L₁:=2(θ(1+θₓ)+θ_{y}(1+θ_{y})+(xₘₐₓ+yₘₐₓ+sₓs_{y})L_{∇ϕ}), xₘₐₓ and yₘₐₓ may be the bounds on the ego vehicle's x and y coordinates, respectively.

Similarly, for k=τ:

Tₖ≤2 |x²(τ)−x¹(τ)|+2|ϕ_{i,x}^{Z}^{₁}(τ−1)−ϕ_{i,x}^{Z}^{₂}(τ−1)|≥L₂∥Z₁−Z₂∥

where

L₂=2(1+θₓ).

Similarly, Tₖ^{y}≤L₁∥Z₁−Z₂∥ for any k ∈ {0, . . . , τ−1}, and Tₖ^{y}≤L₃∥Z₁−Z₂∥, where L₃=2(1+θ_{y}), for k=τ.

Therefore, ∥∇bᵢ(Zᵢ)−∇bᵢ(Z₂)∥≤L_{g}∥Z₁−Z₂∥, where L_{g}=Tₚ(max{L₁, L₃}). Hence, J(Δ, α, Z) in (11) may be Lipschitz differentiable.

### Proof of Theorem 1

Since C may be a full rank matrix, Im(C)= [symbol] ^{4T}^{ₚ}, and hence, D ∈ Im(C). Recall that the feasible sets for Δ, α, and Z may be bounded, e.g., Δ ∈ D, α ∈A, Z ∈ [symbol] . Using these results and Lemmas 1-3, the optimization problem satisfies all the assumptions for convergence of ADMM in non-convex and non-convex and non-smooth optimization. Theorem 1 proves the convergence of Alternating Direction Method of Multiplier (ADMM) Algorithm for any sufficiently large ρ>max {1,(1+2σₘᵢₙ(C))LⱼM}.

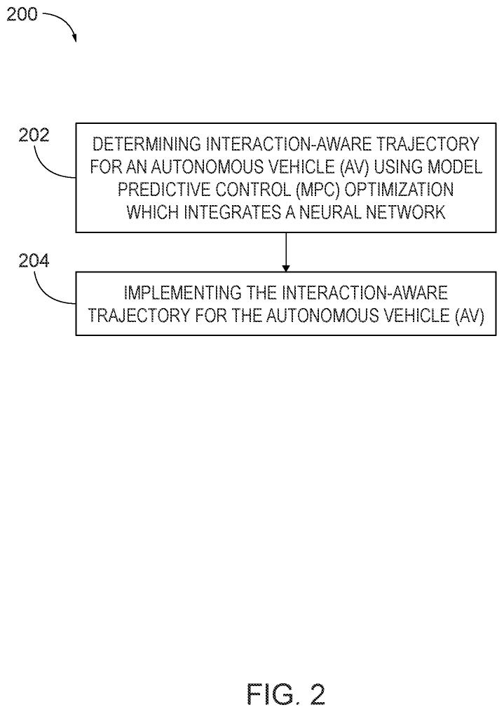

FIG. 2 is an exemplary flow diagram of a computer-implemented method 200 for interaction-aware trajectory planning, according to one aspect. The computer-implemented method 200 for interaction-aware trajectory planning may include determining 202 an interaction-aware trajectory for an autonomous vehicle (AV) traveling in an operating environment including one or more other vehicles using model predictive control (MPC) optimization. The MPC optimization may integrate a neural network which receives one or more observations of the AV 150 and one or more observations of one or more of the other vehicles and outputs predicted trajectories for the AV 150 and one or more of the other vehicles a time step into the future. The computer-implemented method 200 for interaction-aware trajectory planning may include implementing 204 the interaction-aware trajectory for the AV 150.

Although, the problem complexity was reduced by decomposing the optimization problem into smaller sub-problems, these sub-problems may be complex, which makes the approach non-scalable. Nevertheless, having an offline optimization may be useful, as it may serve as a benchmark when developing faster heuristic methods, ideally, would like to increase the efficiency. Approach may be made faster by pre-computing the neural network's gradients and developing faster optimization libraries. Thus, additional features may include designing a smaller network trained with knowledge distillation and pre-computing the gradients offline for a faster implementation.

With the importance of motion planning strategies being interaction-aware, e.g., lane changing in dense traffic for autonomous vehicles, the proposed system investigates mathematical solutions of a model predictive control with a neural network that estimates interactive behaviors. The problem may be highly complex due to the non-convexity of the neural network, and the problem may be effectively solved by decomposing it into sub-problems by leveraging the alternating direction method of multipliers (ADMM). The systems and techniques described herein further examines the convergence of ADMM with the presence of the neural network. The numerical study supports the provably optimal solutions being effective. In this way, a provably optimal solution may be valuable as a benchmark when developing heuristic methods.

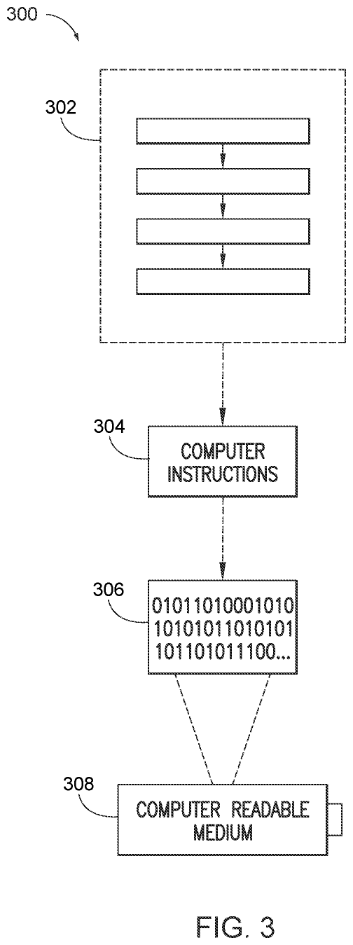

Still another aspect involves a computer-readable medium including processor-executable instructions configured to implement one aspect of the techniques presented herein. An aspect of a computer-readable medium or a computer-readable device devised in these ways is illustrated in FIG. 3, wherein an implementation 300 includes a computer-readable medium 308, such as a CD-ft DVD-R, flash drive, a platter of a hard disk drive, etc., on which is encoded computer-readable data 306. This encoded computer-readable data 306, such as binary data including a plurality of zero's and one's as shown in 306, in turn includes a set of processor-executable computer instructions 304 configured to operate according to one or more of the principles set forth herein. In this implementation 300, the processor-executable computer instructions 304 may be configured to perform a method 302, such as the computer-implemented method 200 of FIG. 2. In another aspect, the processor-executable computer instructions 304 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

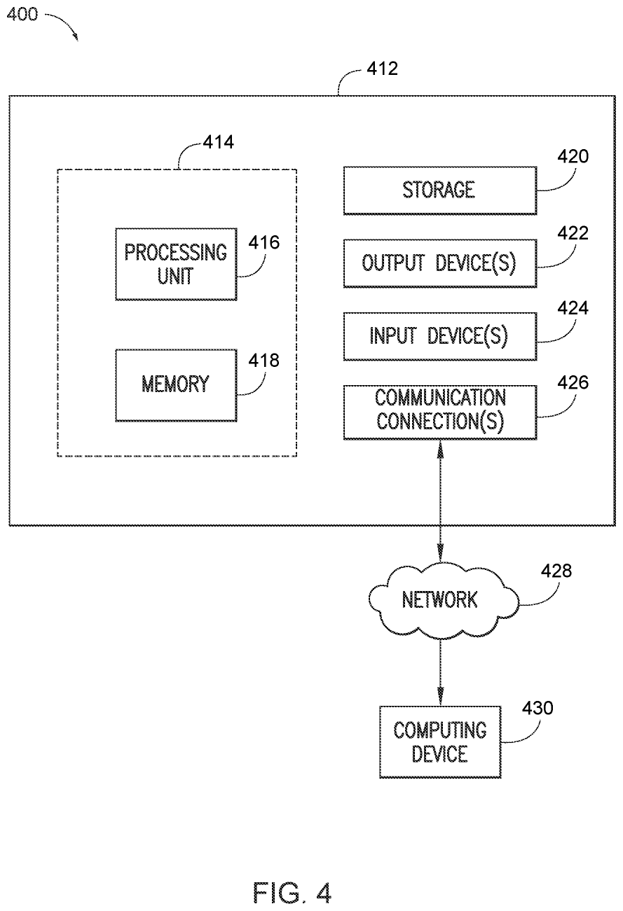

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A system for interaction-aware trajectory planning, comprising:
a memory storing one or more instructions; and
a processor executing one or more of the instructions stored on the memory to perform:
determining an interaction-aware trajectory for an autonomous vehicle (AV) traveling in an operating environment including one or more other vehicles using model predictive control (MPC) optimization,
wherein the MPC optimization integrates a neural network which receives one or more observations of the AV and one or more observations of one or more of the other vehicles and outputs predicted trajectories for the AV and one or more of the other vehicles a time step into the future; and
implementing the interaction-aware trajectory for the AV.

2. The system for interaction-aware trajectory planning of claim 1, wherein the neural network is a social generative adversarial network (SGAN) or a graph-based spatial-temporal convolutional network (GSTCN).

3. The system for interaction-aware trajectory planning of claim 1, wherein the MPC optimization is solved using alternating direction method of multipliers (ADMM).

4. The system for interaction-aware trajectory planning of claim 1, wherein the MPC optimization is based on bicycle kinematics.

5. The system for interaction-aware trajectory planning of claim 1, wherein the MPC optimization is solved such that a non-convex optimization converges to a local optimum.

6. The system for interaction-aware trajectory planning of claim 1, wherein the MPC optimization is solved using canonical convex optimization.

7. The system for interaction-aware trajectory planning of claim 1, wherein the MPC optimization is solved using Broyden-Fletcher-Goldfarb-Shannos sequential quadratic programming (BFGS-SQP) by employing BFGS Hessian approximations within a sequential quadratic optimization.

8. The system for interaction-aware trajectory planning of claim 1, wherein the MPC optimization assumes that outputs of the neural network are bounded.

9. The system for interaction-aware trajectory planning of claim 1, wherein the MPC optimization assumes that gradients of the neural network with respect to an input trajectory of the neural network exist and are bounded.

10. The system for interaction-aware trajectory planning of claim 1, wherein the MPC optimization assumes that the neural network outputs are Lipschitz differentiable.

11. A computer-implemented method for interaction-aware trajectory planning, comprising:
determining an interaction-aware trajectory for an autonomous vehicle (AV) traveling in an operating environment including one or more other vehicles using model predictive control (MPC) optimization,
wherein the MPC optimization integrates a neural network which receives one or more observations of the AV and one or more observations of one or more of the other vehicles and outputs predicted trajectories for the AV and one or more of the other vehicles a time step into the future; and
implementing the interaction-aware trajectory for the AV.

12. The computer-implemented method for interaction-aware trajectory planning of claim 11, wherein the neural network is a social generative adversarial network (SGAN) or a graph-based spatial-temporal convolutional network (GSTCN).

13. The computer-implemented method for interaction-aware trajectory planning of claim 11, wherein the MPC optimization is solved using alternating direction method of multipliers (ADMM).

14. The computer-implemented method for interaction-aware trajectory planning of claim 11, wherein the MPC optimization is solved such that a non-convex optimization converges to a local optimum.

15. The computer-implemented method for interaction-aware trajectory planning of claim 11, wherein the MPC optimization is solved using canonical convex optimization.

16. The computer-implemented method for interaction-aware trajectory planning of claim 11, wherein the MPC optimization is solved using Broyden-Fletcher-Goldfarb-Shannos sequential quadratic programming (BFGS-SQP) by employing BFGS Hessian approximations within a sequential quadratic optimization.

17. The computer-implemented method for interaction-aware trajectory planning of claim 11, wherein the MPC optimization assumes that outputs of the neural network are bounded.

18. The computer-implemented method for interaction-aware trajectory planning of claim 11, wherein the MPC optimization assumes that gradients of the neural network with respect to an input trajectory of the neural network exist and are bounded.

19. The computer-implemented method for interaction-aware trajectory planning of claim 11, wherein the MPC optimization assumes that the neural network outputs are Lipschitz differentiable.

20. A system for interaction-aware trajectory planning, comprising:
a memory storing one or more instructions; and
a processor executing one or more of the instructions stored on the memory to perform:
determining an interaction-aware trajectory for an autonomous vehicle (AV) traveling in an operating environment including one or more other vehicles using model predictive control (MPC) optimization,
wherein the MPC optimization integrates a neural network which receives one or more observations of the AV and one or more observations of one or more of the other vehicles and outputs predicted trajectories for the AV and one or more of the other vehicles a time step into the future,
wherein the neural network is a social generative adversarial network (SGAN) or a graph-based spatial-temporal convolutional network (GSTCN); and
implementing the interaction-aware trajectory for the AV.
